(19) United States
(12) Patent Application Publication
(10) Pub. No.: US 2025/0138134 A1
(43) Pub. Date: May 1, 2025

(54) SYSTEM AND METHOD TO PERFORM LOCALIZATION

(71) Applicant: Whitefall LLC, Augusta, GA (US)

(72) Inventors: Ezra Harris, Augusta, GA (US); Ryan Hogan, Grovetown, GA (US)

(73) Assignee: Whitefall LLC, Augusta, GA (US)

(21) Appl. No.: 18/497,261

(22) Filed: Oct. 30, 2023

(51) Int. Cl. G01S 5/04; G01S 5/02

(52) U.S. Cl. CPC G01S 5/04; G01S 5/02213

(57) ABSTRACT

A method to perform localization is disclosed. The method may be performed by a first device of a plurality of devices distributed non-uniformly in a network. Each device, from the plurality of devices, may be configured to detect or obtain signals from an emitter. The method may include obtaining signals from the emitter and converting the signals into a first complex amplitude. The method may further include broadcasting the first complex amplitude to one or more second devices of the plurality of devices. The method may further include obtaining, by the first device, a second complex amplitude from the second devices, and constructing a correlation matrix based on the first complex amplitude and the second complex amplitude. The method may additionally include determining a line of bearing to the emitter based on the correlation matrix, and determining an emitter location based on the line of bearing.

### TECHNICAL FIELD

The present disclosure relates to a system and method to perform localization and more particularly to a portable direction-finding system to localize an emitter.

### BACKGROUND

Radio direction finding (RDF) is an important tool used in electronic warfare and signals intelligence, as well as in air space and spectrum management. Direction finding devices use different types of RDF techniques to localize a target including Manual, Doppler, Time Difference of Arrival (TDOA), Watson-Watt, Angle of Arrival (AOA), Correlative Interferometry, and/or the like. Direction finding (DF) relies on the transversality of electromagnetic waves. Every DF process employs one of two methods. The first method is measuring directions of electric and/or magnetic field vectors. The second method is measuring orientations of surfaces of equal phase.

In order to conduct phase direction finding based on direction patterns, partial waves must be coupled at various points of the antenna system and combined at one point to form a sum signal. The maximum of the sum signal occurs at the antenna angle at which the phase differences between the partial waves are minimum.

Conventional RDF systems are inflexible as they are fixed. Further, conventional RDF systems use heavy equipment, which makes it difficult for a user to conveniently carry such systems. Therefore, there exists a need for an RDF system that may be flexible, easy to carry and provide accurate output.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example method to perform localization in accordance with the present disclosure.

FIG. 3 depicts snapshots of example steps associated with the method of FIG. 2 in accordance with the present disclosure.

FIG. 4 depicts an example localization process executed by one or more sensors in accordance with the present disclosure.

FIG. 5 depicts an example representation of a sensor to reference plot in accordance with the present disclosure.

FIGS. 6A and 6B depict polar plots of signal space in accordance with the present disclosure.

FIG. 7 depicts a flow diagram an example method to determine a line of bearing in accordance with the present disclosure.

### DETAILED DESCRIPTION

### Overview

The present disclosure describes a radio direction finding system configured to use radio waves to determine a direction in which a radio station or an object (e.g., an emitter) may be located. The system may include a plurality of portable and lightweight devices that may be carried by different users in a geographical area, and may be communicatively coupled with each other by a wireless network. Each device may include a sensor that may broadcast information/signals/data to other sensors by using software-defined radio.

Each sensor may be configured to determine its own position using Global Positioning System (GPS) and may broadcast the position information (along with metadata such as sensor identifier number) to other sensors in the network. Stated another way, the sensors may be configured to exchange position information with each other. Responsive to exchanging the position information, each sensor may be configured to calculate a position matrix that may indicate sensor positions relative to each other.

In some aspects, each sensor may be configured to monitor signals emitted from the emitter. When a sensor receives a signal that may have a signal strength greater than a predetermined threshold, the sensor may broadcast signal data to other sensors. In some aspects, the sensor may convert power data associated with the signal into a complex amplitude, and may broadcast the complex amplitude to the other sensors. Stated another way, the sensors may exchange complex amplitudes with each other.

In further aspects, each sensor may be configured to calculate a correlation matrix based on the complex amplitudes. In addition, each sensor may be configured to calculate an array manifold based on the position matrix and a wave vector. Based on the correlation matrix and the array manifold, each sensor may be configured to determine a line of bearing to the emitter. Each sensor may determine an emitter location based on the line of bearing. In some aspects, triangulation may be conducted to generate a fix using the plurality of sensors, and the emitter location may be displayed as a heat map on display units associated with each sensor. In this manner, the system determines precise emitter location. In other cases the sensor uses a direct position scheme to determine the relative location of an emitter. The direct position scheme maximizes the signal subspace and then uses a gaussian search cone to refine the position information.

The present disclosure discloses a system including a plurality of sensors that are lightweight and portable, and configured to determine an accurate emitter location. The sensors may be easily carried by users in the field to determine the emitter location, and hence use of conventional bulky and stationary direction finding systems may be eliminated.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

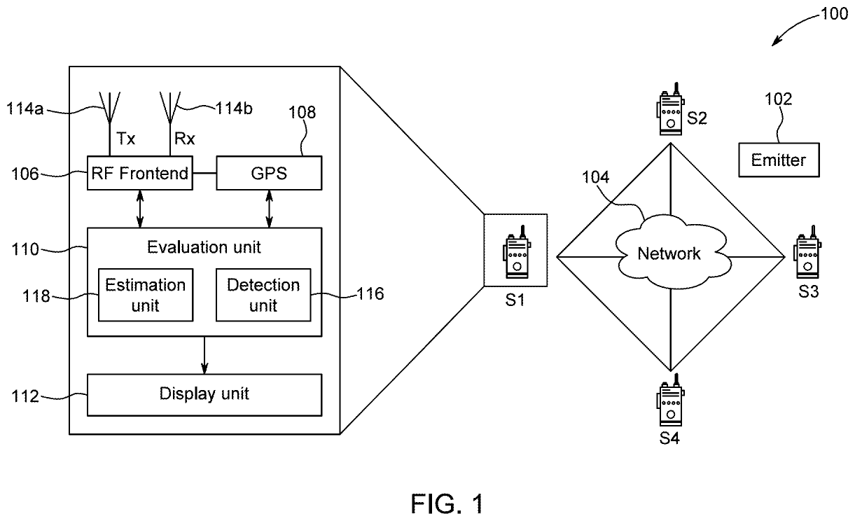

FIG. 1 depicts an example environment 100 in which techniques and structures for providing the systems and methods disclosed herein may be implemented. The environment 100 may include a direction-finding system (“system”). The system may be configured to use radio waves to determine a direction in which a radio station or an object (e.g., an emitter 102 described later below) may be located. Stated another way, the system may be configured to use radio waves to determine an emitter location/position.

The system may include a plurality of portable and lightweight devices that may be carried by different users. The users may be distributed in a geographical area, and hence the plurality of devices may also be distributed in a non-uniform manner in the geographical area (and may be moving). Each device may act as a “reference” device and may be configured to monitor signals emitted from the emitter 102. When any one device, from the plurality of devices, detects a signal greater having a signal strength greater than a predetermined threshold, the device broadcasts the signal (e.g., a complex amplitude associated with the signal) to other devices, modulated with metadata indicating the sending sensor (e.g., sensor identifier number). Each device may be configured to calculate a line of bearing to the emitter 102 based on the information obtained from other devices and the signals obtained from the emitter 102, to determine the emitter location/position. Each device may be light-weight, small-scale, flexible, and portable which may enable the user to conveniently carry the device and determine emitter location with ease.

In some aspects, each device may include one or more sensors that may be configured to receive signals emitted from the emitter 102. In the exemplary aspect depicted in FIG. 1, the devices are shown as sensors. For example, as shown in FIG. 1, the system may include a plurality of sensors including, but not limited to, a first sensor “S1”, a second sensor “S2”, a third sensor “S3”, a fourth sensor “S4”, and/or the like. The plurality of sensors (S1, S2, S3, and S4) may be connected with each other via a wireless network 104. The plurality of sensors S1-S4 collectively may produce four output signals in an RF network of four coherent measurement channels.

Each sensor may be configured to broadcast information/signals/data to other sensors by using software-defined radio. Further, each sensor may be configured to receive information/signals/data from other sensors using software-defined radio. Furthermore, as described above, each sensor may act as a reference sensor and may be configured to calculate a line of bearing to the emitter 102 (e.g., to determine the emitter location relative to the sensor, and plot the emitter location on a GPS map).

In some aspects, each sensor (e.g., the first sensor S1) may include a plurality of units including, but not limited to, a radio frequency (RF) front end 106 (or a transceiver), a Global Positioning System (GPS) receiver 108 (or GPS 108), an evaluation unit 110 and a display unit 112, which may be communicatively coupled to each other.

The radio frequency (RF) front end 106 may be configured to transmit and receive RF signals using antennas 114a, 114b (which may be, e.g., helical antennas). In an exemplary aspect, the RF front end 106 may be configured to receive signals from the emitter 102 and/or other sensors. The RF front end 106 may include a plurality of components that may perform conversion of analog RF signals to digital signals, and vice-versa. In some aspects, the antennas 114a, 114b may convert electrical signals into electromagnetic (EM) waves for transmission, and vice versa for reception of radio signals. Since the system includes the plurality of sensors S1-S4 distributed a non-uniform manner in the geographical area (as described above) and each sensor includes antennas 114a, 114b, a person ordinarily skilled in the art may appreciate that the system includes a non-uniform/distributed antenna array.

The RF front end 106 may further include additional components (not shown) such as filters, power amplifiers, frequency converters, and/or the like.

The GPS 108 may be configured to detect sensor location/position associated with the first sensor S1 (“first sensor location”) on Earth. The evaluation unit 110 may uses a linux debian distribution as the operating system and a custom RF front end as the software to define the radio. The evaluation unit 110 may be configured to obtain inputs from the RF front end 106 and the GPS 108, and may be configured to determine an emitter location based on the obtained inputs. In some aspects, the evaluation unit 110 may include a detection unit 116 and an estimation unit 118. In some aspects, the detection unit 116 may be configured to monitor signals emitted from the emitter 102, and the estimation unit 118 may be configured to estimate the emitter location.

The display unit 112 may be configured to display the emitter location determined by the evaluation unit 110.

As described above, the evaluation unit 110 may obtain inputs from the GPS 108. The inputs may include the first sensor location. The evaluation unit 110 may be further configured to broadcast the first sensor location to other sensors or second sensors (e.g., sensors S2-S4) via the RF front end 106. In addition, the evaluation unit 110 may be configured to obtain locations/positions of the second sensors (“second sensor locations”) from respective sensors via the RF front end 106 (which may be broadcasted by radio frequency front ends of respective sensors). Responsive to obtaining the first sensor location from the GPS 108 and the second sensor locations from respective second sensors, the evaluation unit 110 may calculate or generate a position matrix based on the first sensor position and the second sensor locations. The position matrix indicates the first sensor position relative to the second sensor positions.

Further, as described above, the evaluation unit 110 may be configured to monitor signals emitted from the emitter 102 via the detection unit 116. In some aspects, the detection unit 116 may be configured to collect signals emitted from the emitter 102 at a predetermined frequency in the compute loop to ensure data coherence. The detection unit 116 may filter the signals using Fast Fourier Transform (FFT) and covert the filtered data to a digital signal (e.g., by using a common clock provided by GPS), and then down convert it to a low frequency signal. Responsive to converting the filtered data to the digital signal, the detection unit 116 may feed the digital signal to a signal processing unit (not shown) associated with the detection unit 116 to collect/generate scan points (or signal samples). In some aspects, a quantity of samples to be collected by the detection unit 116 may be based on a pre-selected averaging time. In the case of distributed measurement channels, the averaging time for collection may be twice the time duration of a largest signal in the scanning band. The detection unit 116 may feed the signal samples to the estimation unit 118 for angle of bearing calculation.

As described above, the estimation unit 118 may be configured to collect power data and frequency data associated with the emitter 102, e.g., based on the signal samples obtained from the detection unit 116. The evaluation unit 110 may be further configured to convert the power data into a complex amplitude (e.g., a first complex amplitude), and may broadcast the first complex amplitude to the second sensors via the RF front end 106. In some aspects, the evaluation unit 110 may convert and broadcast the first complex amplitude when the signal strength associated with the signal received from the emitter 102 may be above a predetermined threshold level value. In addition, the evaluation unit 110 may broadcast the first complex amplitude along with the metadata indicating the sending sensor (i.e., the first sensor S1). The other/second sensors may receive and compare the signal data obtained from the first sensor S1 with their respective signal data. Further, the evaluation unit 110 may obtain second complex amplitude data from the second sensors. The second complex amplitude may be calculated in the similar manner as the first complex amplitude.

In addition, the evaluation unit 110 may be configured to construct a correlation matrix based on the first complex amplitude and the second complex amplitude. In some aspects, maximum complex amplitudes may be used as scan points to construct the correlation matrix. In some aspects, the evaluation unit 110 may use 1024 scan points to create the correlation matrix. In further aspects, the evaluation unit 110 may generate the correlation matrix using the signals that may be complete (e.g., present in the same frequency band with similar complex amplitudes). The evaluation unit 110 may further perform eigen decomposition of the correlation matrix. The evaluation unit 110 may then order the eigenvalues in descending order and sort the eigenvectors accordingly. Further, the evaluation unit 110 may partition the signal and noise subspace based on signal strength. In further aspects, the evaluation unit 110 may calculate a line of bearing to the emitter 102 using multiple signal classification (MUSIC) algorithm.

In additional aspects, the evaluation unit 110 may be configured to calculate an array manifold (e.g., a first array manifold) via the estimation unit 118. The array manifold may be a function of azimuth and elevation angle of incidence data associated with the signal received from the emitter 102, and may be a surface embedded in N-dimensional complex space. In some aspects, the evaluation unit 110 may calculate the array manifold based on the position matrix (as specified by GPS and communicated with the sensor meta data via radio to the other devices) and a wave number vector. In some aspects, the wave number vector may be created from the azimuth and elevation angle of the incidence data. Stated another way, the wave number vector may be a function of azimuth and elevation angle of incidence data. In further aspects, the evaluation unit 110 may be configured to determine a line of bearing to the emitter 102 based on the array manifold and the eigen decomposition to perform the localization of the emitter 102.

In some aspects, the evaluation unit 110 may be further configured to calculate a second array manifold relative to the emitter location. In some aspects, the evaluation unit 110 may be further configured to calculate the second array manifold based on the line of bearing. The evaluation unit 110 may then use the second array manifold and the signal subspace to create a distribution function that may be maximized to determine the emitter position. The emitter position may then be plotted on a GPS map and displayed on the display unit 112.

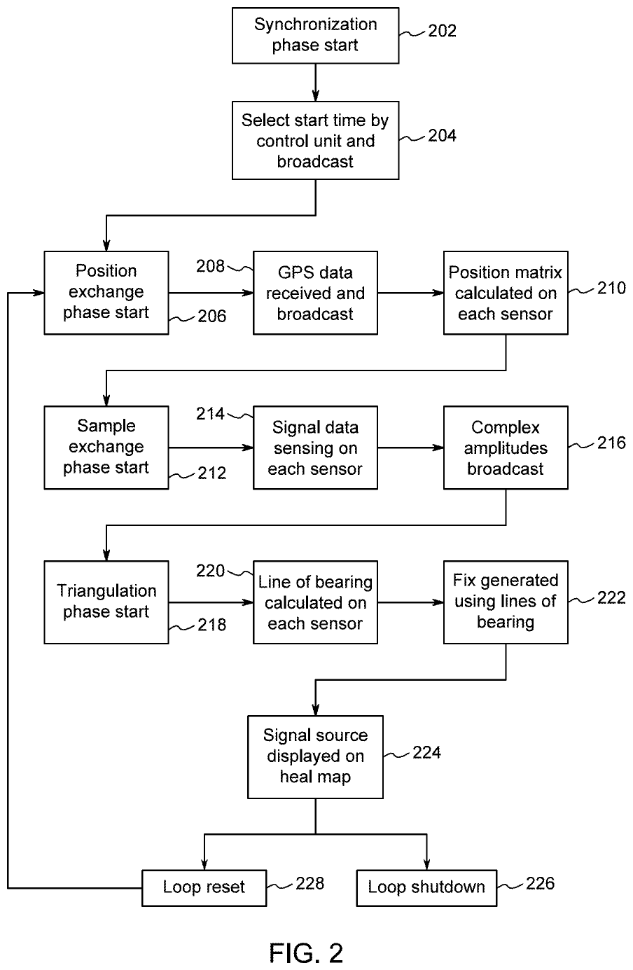

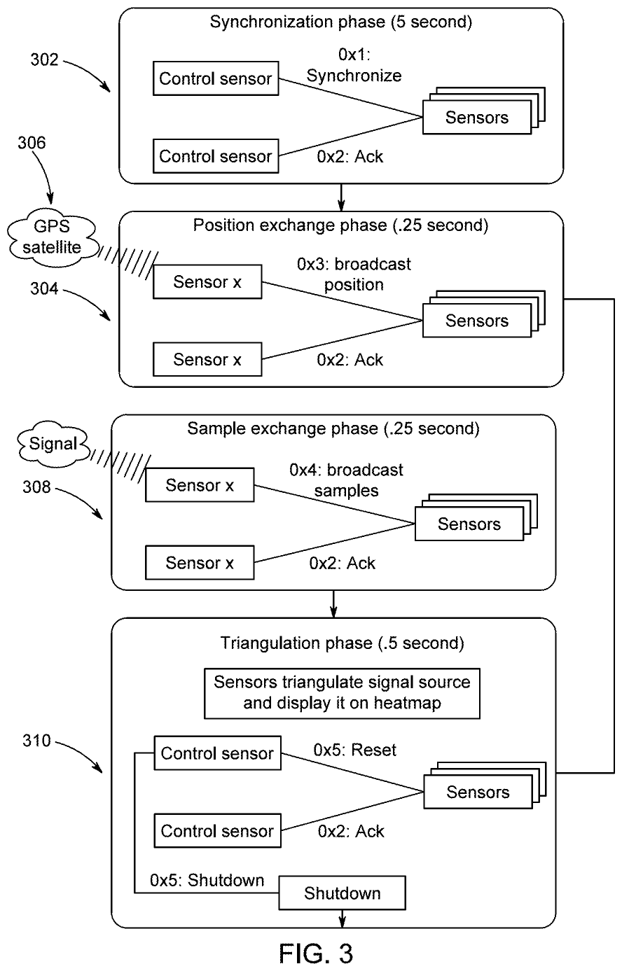

FIG. 2 depicts an example method 200 to perform localization in accordance with the present disclosure. In some aspects, the method 200 may be executed by the evaluation unit 110. While explaining FIG. 2, references will be made to FIG. 3.

The method 200 starts at step 202. At the step 202, the synchronization phase starts. At step 204, a control sensor or the first sensor (e.g., the first sensor S1) selects a start time and broadcasts the start time to other sensors or the second sensors (e.g., the sensors S2-S4) to perform synchronization with each other. An example synchronization phase is shown in view 302 of FIG. 3. Specifically, the view 302 illustrates that the first sensor S1 broadcasts a signal to synchronize with the second sensors. The second sensors may receive the broadcasted signal and may transmit an acknowledgement signal to the first sensor S1 to enable synchronization between the sensors. In some aspects, the synchronization process may take a time duration in a range of 2-10 seconds.

At step 206, the position exchange phase starts in which the sensors exchange respective positions with each other to calculate a position matrix. At step 208, the method 200 may include obtaining, by each sensor (e.g., the first sensor S1), GPS data (e.g., the first sensor position) and broadcasting the obtained first sensor position to the second sensors. In addition, at this step, the first sensor S1 may receive/obtain the second sensor positions. An example position exchange phase is shown in view 304 of FIG. 3. Specifically, the view 304 illustrates that sensor “X” (e.g., the first sensor S1) receives signal (or position information) from a GPS satellite 306 and broadcasts the position information to the second sensors. The second sensors may receive the position information from the first sensor S1 and may transmit an acknowledgement signal to the first sensor S1. In some aspects, the second sensors may also transmit their own position information to the first sensor S1.

At step 210, the method 200 may include calculating, by each sensor (e.g., the first sensor S1), the position matrix based on the position information associated with the other sensors. For example, the evaluation unit 110 may calculate the position matrix based on the position information obtained, via the RF front end 106, by the first sensor S1 from the other sensors or the second sensors. The position matrix may indicate the first sensor position relative to the second sensor positions.

At step 212, the sample exchange phase start in which the sensors exchange signal data obtained from the emitter 102 with each other. At step 214, the method 200 may include sensing or monitoring, by each sensor (e.g., the first sensor S1), signal data from the emitter 102. At step 216, the method 200 may include broadcasting, by the first sensor S1, complex amplitude to the second sensors. As described above, the evaluation unit 110 may receive the signal having power data and frequency data from the emitter 102, and convert the power data to the complex amplitude, and then broadcast the complex amplitude to the second sensors. In some aspects, the evaluation unit 110 may convert and broadcast the complex amplitude when the signal strength may be above a predetermined threshold level. An example sample exchange phase is shown in view 308 of FIG. 3. Specifically, the view 308 illustrates that sensor “X” (e.g., the first sensor S1) receives the signal from the emitter 102 and broadcasts the signal samples associated with emitter 102 to the second sensors. The second sensors may receive the signal samples from the first sensor S1 and may transmit an acknowledgement signal to the first sensor S1.

At step 218, the triangulation phase starts in which the sensors determine the emitter location based on the signal data received by each sensor. At step 220, the method 200 may include calculating, by each sensor (e.g., the first sensor S1), a line of bearing based on the complex amplitude. At step 222, the method 200 may include generating, by each sensor (e.g., the first sensor S1), fix using the line of bearing. At step 224, the method 200 may include displaying, by each sensor (e.g., the first sensor S1), a signal source location (e.g., the emitter location) on a heat map on the display unit 112. At step 226, the loop shutdown happens, and the loop resets at step 228. An example triangulation phase is shown in view 310 of FIG. 3. Specifically, the view 310 illustrates that sensors triangulate the signal and display it on the heat map. The control sensor or the first sensor S1 may transmit a reset signal to the second sensors. The second sensors may receive the reset signal from the first sensor S1 and may transmit an acknowledgement signal to the first sensor S1. In addition, the first sensor may shutdown the loop.

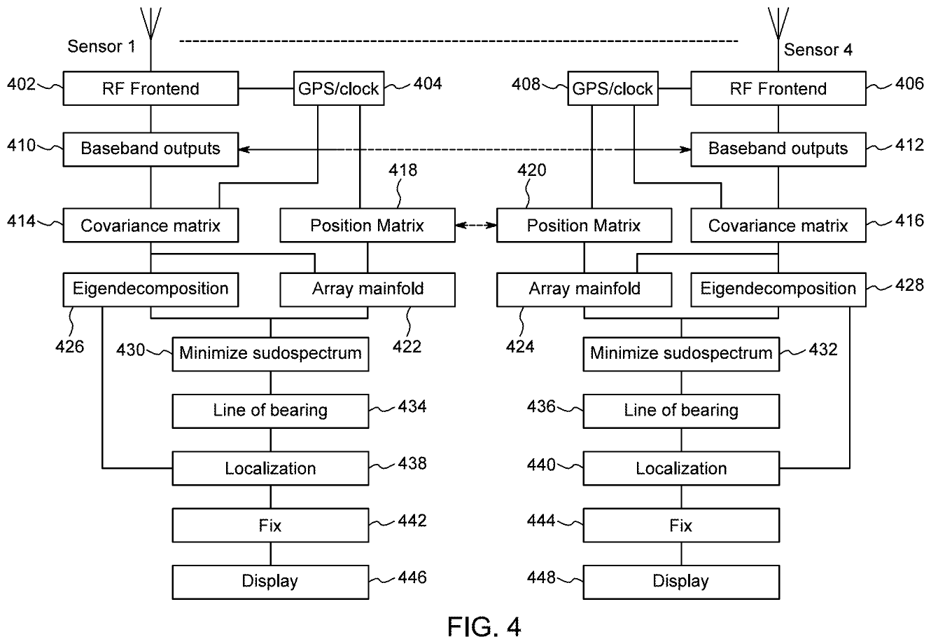

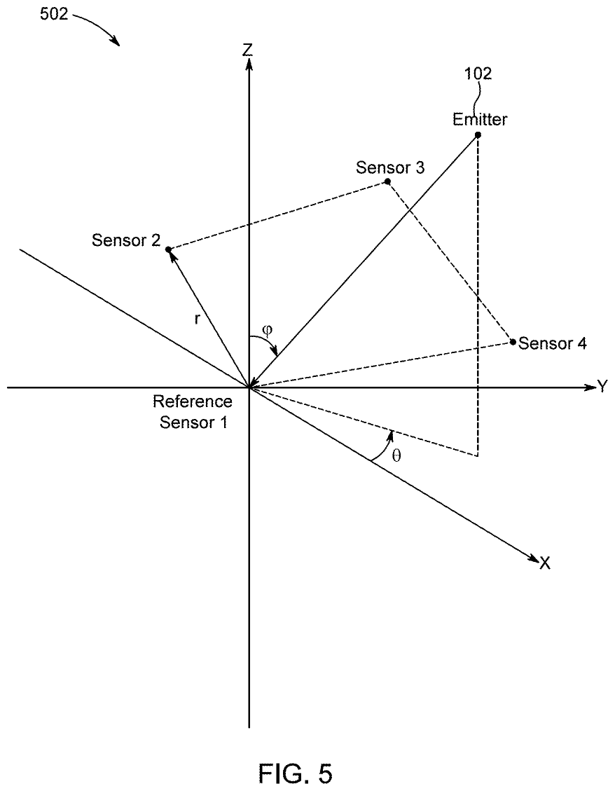

FIG. 4 depicts an example localization process in accordance with the present disclosure. While explaining FIG. 4, references will be made to FIG. 5. In some aspects, the localization process depicted in FIG. 4 illustrates the process for performing localization or determining the emitter location by using the sensors S1-S4.

In FIG. 4, a radio frequency (RF) frontend (e.g., the RF front end 106 associated with the first sensor S1) is represented by a block 402 and a GPS/clock is represented by a block 404. Similarly, an RF frontend of another sensor or second sensor (e.g., the sensor S4) is represented by a block 406 and a GPS/clock associated with the second sensor is represented by a block 408.

As described above in conjunction with FIG. 2, the sensors (S1-S4) may be synchronized with each other using network timing protocol (e.g., using the clock). When the sensors are synchronized, each sensor may monitor or receive the signals emitted from the emitter 102.

Each sensor (including sensors S1 and S4) may exchange baseband output with each other, as illustrated in blocks 410 and 412. As described above in conjunction with FIG. 1, the sensors may convert the received signals into complex amplitude and broadcast the complex amplitude to other sensors. In some aspects, each sensor may further array stack signals to construct covariance matrix, as illustrated in blocks 414 and 416.

In addition, each sensor may determine its own position by using respective GPS, and broadcast information associated with the position to other sensors. Stated another way, each sensor may communicate respective position (along with metadata such as sensor identifier number associated with the sensor) with other sensors. Each sensor may additionally receive position information associated with the other sensors and construction a position matrix r, as illustrated in blocks 418 and 420. The position matrix is generated from the location associated with the sensors from the reference in half wavelengths. An example mathematical expression for the position matrix is illustrated below.

$$r = [ \begin{matrix}x 1 & y 1 & z 1 \\ x 2 & y 2 & z 2 \\ x 3 & y 3 & z 3\end{matrix} ]$$

In further aspects, each sensor may calculate an array manifold using the position matrix and a wave number vector, as illustrated in blocks 422 and 424. The wave number vector may be created from an azimuth angle of incidence data θ and an elevation angle of incidence ϕ (associated with the signal received from the emitter 102), as shown in graph 502 of FIG. 5.

In addition, each sensor may perform eigen-decomposition (as illustrated in blocks 426 and 428) and then order the eigenvalues in descending order to sort the eigenvectors accordingly. Thereafter, each sensor may partition the signals obtained from the emitter 102 into the signal and noise subspace based on signal strength. Each sensor may further save the signal and noise subspace.

In some aspects, each sensor may multiply noise subspace by the conjugate transpose of the array manifold and take the reciprocal to yield the MUSIC pseudo-spectrum. The asymptotes of the spectrum are the estimated angle of arrival associated with the signals emitted from the emitters (e.g., the emitter 102). In some aspects, the pseudo spectrum may be created by using a search algorithm by varying the wavenumber vector through an azimuth and elevation angle until the noise subspace is minimized, as illustrated in blocks 430 and 432. Each sensor may then calculate the line of bearing using the angle of arrival (as illustrated in blocks 434 and 436), perform localization (as illustrated in blocks 438 and 440), fix and display the emitter location (as illustrated in blocks 442, 444, 446, and 448).

In some aspects, each sensor may create an array manifold of an emitter (e.g., the emitter 102) at an unknown point using the estimated angle of arrival associated with the signal emitted from the emitter 102. Each sensor may reduce the dimensionality of search by converting the array manifold into a diagonal matrix using the Kronecker product of the identity matrix of the same rank as the number of sensors and a vector of ones with the same rank as sensors. Each sensor may use an estimated attenuation constant to construct a cost function using the signal subspace, and calculate the converted array manifold created above. Each sensor may multiply the cost function by the maximum eigen-value of the covariance matrix creating a distribution function, and search distribution function for a maximum yielding position associated with the emitter 102. The sensor may further plot distribution function as an overlay with the background being a GPS map of an environment in front of the user associated with the sensor.

In some aspects, the Electromagnetic waves in the far field limit propagate as a plane wave given by an example mathematical expression illustrated below:

$$ψ ( t ) = {Ae}^{i ( kx - ω t )}$$

where, k is the wave vector, and ω is the angular frequency associated with the wave.

Specifically, the sensors measure data as ψ₁(t), ψ₂(t), ψ₃(t), . . . ψₙ(t) with a frequency of f₀ and a wave-length of λ₀, arriving at the reference point at an angle of incidence θ₀ with a direction from the reference point to the n-th sensor at an angle ϕₙ and a distance of rₙ, as shown in the graph 502 of FIG. 5. The antenna dependent characteristics associated with the sensor may be described by the term cₙ(θₚ). The signal output at the n-th sensor can be modeled by using an example mathematical expression illustrated below:

$$ψ ( t ) = {A}_{n} ( t ) {e}^{i ( kx - ω t )} {c}_{n} ( {θ}_{p} ) {e}^{i 2 π / {λ}_{0} \vert {r}_{n} \vert Κ} + v ( t )$$

where, Aₙ(t) depicts complex amplitude and v(t) depicts frequency data or noise.

In further aspects, each sensor may construct an array manifold a (rₙ, θ, ϕₙ) which represents the hyper-surface embedded in a complex space. The manifold for a four-antenna system may be modeled by an example matrix illustrated below with the fourth antenna being a reference at the origin.

$$a ( {r}_{p} , θ , {Φ}_{n} ) = ( \begin{matrix}{e}^{i 2 π / {λ}_{0} \vert {r}_{n} \vert k} \\ {e}^{i 2 π / {λ}_{0} \vert {r}_{n} \vert k} \\ {e}^{i 2 π / {λ}_{0} \vert {r}_{n} \vert k}\end{matrix} )$$

Where κ is the wave number vector illustrated by an example mathematical expression provided below.

$$k = ( \begin{matrix}cos ϕcosθ \\ cos ϕsinθ \\ sin ϕ\end{matrix} )$$

The array manifold depends on the magnitude of the position vector r associated with the antenna/sensor from the reference to the n-th sensor measured from the normal, the angle of incidence of the wave on the reference sensor θ, and the angle from the reference to the n-th sensor ϕₙ. The set of all direction vectors in the matrix then sweeps out the manifold given that wave angle is continuously varied across the range of interest. The tip of the direction vector describes a curve in the N dimensional space. Then the sum of the product of the amplitude of the complex signals and the variable array manifold is calculated, and then Gaussian noise is added to create y[k], the vector of signals at the array output as a sampling rate function. An example mathematical expression associated with y[k] is illustrated below.

$$y [ k ] = {\sum }_{{p = 1}^{}}^{p} {s}_{p} [ k ] a ( {r}_{p} , θ , {ϕ}_{n} ) + v [ k ]$$

In order to find the angles of bearing, the evaluation unit 110 estimates the sample covariance matrix Ry illustrated by an example mathematical expression provided below.

$${R}_{y} = {\sum }_{k = 1}^{K} y [ k ] {y [ k ]}^{H}$$

Thereafter, the evaluation unit 110 performs the eigenvalue decomposition of the estimated covariance matrix with Gaussian noise illustrated by an example mathematical expression provided below.

$${R}_{y} = {UR}_{s} {U}^{H} + {σ}^{2} I$$

where U is the matrix of singular values, Rₛ is the expectation value of the complex amplitudes and σ² is the signal to noise ratio associated with the received signals. Since ω₂>0, R_{y} is a full rank matrix with M positive eigenvalues λ₁, λ₂ . . . λₘ, with M corresponding eigenvectors Λ₁, Λ₂ . . . Λₘ. The eigenvalues of the matrix R_{y} are sorted in accordance with size, as depicted below.

$${λ}_{1} \geq {λ}_{1} \geq {⋯λ}_{m}$$

In some aspects, larger eigenvalues D correspond to the signal subspace while M-D smaller eigenvalues correspond to the noise subspace. In some aspects, the eigenvalue problem may be formulated by an example mathematical expression illustrated below.

$${R}_{y} {Λ}_{m} = {σ}^{2} {Λ}_{m}$$

Thereafter, the evaluation unit 110 substitutes the explicit form of the covariance matrix into the eigenvalue problem illustrated by an example mathematical expression provided below.

$$( {R}_{y} = {UR}_{s} {U}^{H} + {σ}^{2} I ) {Λ}_{m} = {σ}^{2} {Λ}_{m}$$

The evaluation unit 110 then expands the left side of the equation and cancels the noise terms yielding the following mathematical expression:

$${UR}_{s} {U}^{H} {Λ}_{m} = 0$$

Because U^{H}U is a fully ranked matrix and (U^{H}U)⁻¹ exists, Rₛ⁻¹ also exists. The evaluation unit 110 then multiplies both sides of the eigenvalue problem by Rₛ⁻¹(U^{H}U)⁻¹U^{H}. Upon canceling like terms, an example mathematical expression like the one shown below may be derived:

$${U}^{H} {Λ}_{m} = 0 \qquad m = D + 1 … . M$$

The preceding mathematical equation indicates that the eigenvector corresponding to the noise eigenvalue may be perpendicular to the column vector of the matrix U. Thus each row of U may correspond to the signal source direction (i.e., the emitter 102).

In further aspects, the evaluation unit 110 may construct the noise matrix Un by using noise characteristic value as illustrated by a mathematical expression provided below.

$${U}_{n} = [ {Λ}_{D + 1} , {Λ}_{D + 2} … . {Λ}_{M} ]$$

The evaluation unit 110 may yield the MUSIC pseudo spectrum as illustrated by a mathematical expression provided below.

$$= \frac{1}{{\vert {U}_{n}^{H} a ( r , θ , ϕ ) \vert}^{2}}$$

The pseudo spectrum's denominator of the formula is an inner product of the noise subspace and the array manifold. The pseudo spectrum plots decibels as a function of the angle. The maximum of the function is the angle of bearing associated with the emitter 102 relative to the reference of the antenna array.

In order to determine the position of the emitter 102, one step localization algorithm may be used, and a three-dimensional search may be conducted over the environment. One step localization process provides position data of emitters by selecting peaks of the distribution function and may provide benefit over two step triangulation. The present disclosure describes formulating the problem in a similar way to the MUSIC algorithm, where the task is to determine P transmitters with L reference sensors. The p^{th} transmitter may be defined by a 3×1 vector of coordinates qₚ. The complex envelop is then attenuated by the channel attenuation bₗₚ between the p^{th} transmitter and the Ith base station. An example mathematical expression is illustrated below.

$$ψ ( t ) = {A}_{n} {b}_{lq} {e}^{i ( kx - ω t )} {c}_{n} ( {θ}_{p} ) {e}^{i \frac{2 π}{{λ}_{0}} \vert {r}_{n} \vert k} + v ( t )$$

The present disclosure further describes constructing the vector of signals observed at the lth reference sensor by using the Ith array response aₗ(qₚ) to the signal transmitted from position qₚ and the signal waveform. An example mathematical expression is illustrated below.

$$y [ k ] = {\sum }_{p = 1}^{p} {b}_{lp} {s}_{p} [ k ] a ( {p}_{q} ) + v ( k )$$

It is assumed that the signal wave form is the same and unknown at all reference sensors (i.e., S1-S4) and the attenuation coefficient is real and the same at each reference sensor. The evaluation unit 110 may follow the same steps as the MUSIC algorithm to find the signal and noise subspaces. Using the signal subspace Uₛ, a cost function may be constructed, whose example mathematical expression is illustrated below.

$$F [ p , {q}_{p} , {b}_{lq} ] = {\sum }_{p = 1}^{p} {( a ( {q}_{p} , {b}_{lq} ) )}^{H} {U}_{s} {U}_{s}^{H} a ( {q}_{p} , {b}_{lq} ) {b}_{lq}$$

The signal subspace is an ML×P matrix consisting of the P largest eigen-vectors of the vector of observed signals. In order to reduce the dimensionality of the search, a(qₚ, b_{lq}) may be represented using the diagonal matrix Γ(p) whose elements are the array manifolds at all base stations, and H is the Kronecker product of the L×L identity matrix and a M×1 vector of ones. Associated example mathematical expressions are illustrated below.

$$a ( {q}_{p} , {b}_{lq} ) = Γ ( p ) {Hb}_{ql}$$

$$Γ ( p ) = diag [ {a}_{1}^{T} ( q ) , … .. {a}_{L}^{T} ( q ) ]$$

$$H = I ⊗ {1}_{m}$$

The maximum of the cost function may then correspond to the maximal eigenvalue of the matrix D(p), as illustrated in an example mathematical expression provided below.

$$D ( q ) = {H}^{H} [ {\sum }_{p} {Γ}^{H} {U}_{s}^{H} Γ ] H$$

In some aspects, the cost function may be re-written as an example mathematical expression illustrated below.

$$F ( q ) = {λ}_{max} [ D ( q ) ]$$

The matrix D(q)) is a function of the observed data. For planar geometry, the cost function requires a two-dimensional search to find an emitter located at q. For the general case, a three-dimensional search may be conducted. The dimensions of the matrix D(q) may be L×L.

In further aspects, in order to conduct the direct position determination, the evaluation unit 110 may calculate the cost function as a function of the array manifold, signal subspace, and the channel attenuation relative to the emitter 102 to be localized. The evaluation unit 110 may then convert the cost function into polar coordinates with units of degrees and kilometers and plot the signal subspace modified by the array manifold relative to the emitter 102. In order to tune the search results, the evaluation unit 110 may use a Gaussian search cone with a standard deviation of σ=0.25. An example Gaussian function expression is shown below.

$$f ( x ) = \frac{1}{σ \sqrt{2 π}} {e}^{- \frac{1}{2} {( \frac{x - μ}{σ} )}^{2}}$$

In some aspects, in the expression illustrated above, x is range; μ is array of peaks; and σ is breadth of the cone.

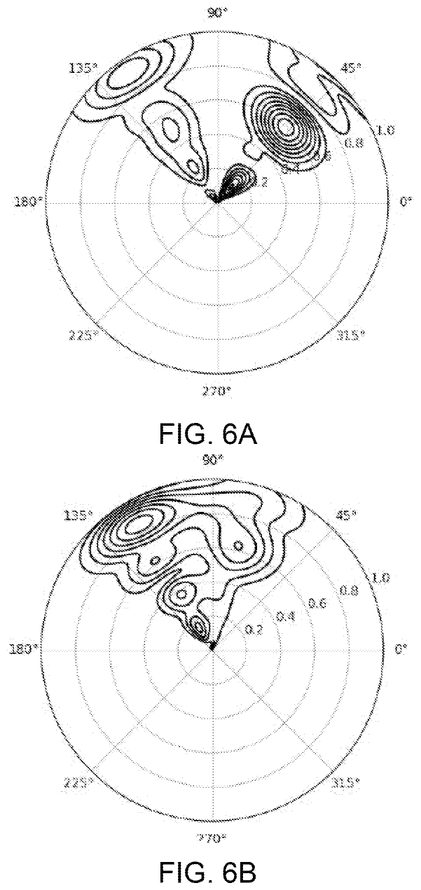

The evaluation unit 110 may then plot the signal space as a function of the product of the cost function and distribution function, as indicated in FIGS. 6A and 6B. Specifically, FIG. 6A depicts a polar plot of signal space at degrees 50 and 120, and FIG. 6B depicts a polar plot of signal space at degrees 80 and 120.

The search cone is extremely effective at parsing the signal environment and creates distinct areas of probable emitter locations. When the proposed emitter locations are close together there is some level of signal mixing that degrades the fidelity of the localization process. The signal subspace plot may be created to improve the sensitivity of the emitter localization process so that noise does not significantly affect the ability of the evaluation unit 110 to determine the range of the emitter 102. In some aspects, the evaluation unit 110 may further reduce the harmonic effects on the radial axis of the search cone.

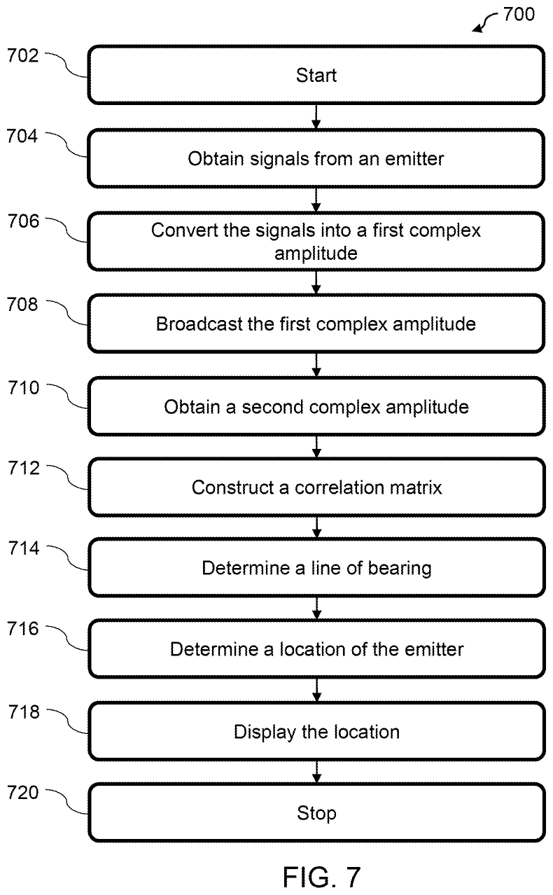

FIG. 7 depicts a flow diagram an example method 700 to determine a line of bearing in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

At step 702, the method 700 may commence. At step 704, the method 700 may include obtaining, by the first sensor S1 from the plurality of sensors S1-S4, signals from the emitter 102. As described above, the plurality of sensors S1-S4 may be communicatively coupled with each other and distributed non-uniformly in a network. Further, each sensor, from the plurality of sensors S1-S4, may be configured to obtain the signals from the emitter 102.

At step 706, the method 700 may include converting, by the first sensor S1, the signals obtained from the emitter 102 into a first complex amplitude. At step 708, the method 700 may include broadcasting, by the first sensor S1, the first complex amplitude to one or more second sensors, e.g., the sensors S2-S4.

At step 710, the method 700 may include obtaining, by the first sensor S1, a second complex amplitude from the second sensors S2-S4. At step 712, the method 700 may include constructing, by the first sensor S1, a correlation matrix based on the first complex amplitude and the second complex amplitude. At step 714, the method 700 may include determining, by the first sensor S1, a line of bearing to the emitter 102 based on the correlation matrix. At step 716, the method 700 may include determining an emitter location based on the line of bearing. Stated another way, the method 700 may further include performing localization of the emitter 102 based on the line of bearing. In some aspects, triangulation may be conducted to generate a fix using the plurality of sensors S1-S4. At step 718, the method 700 may include displaying the emitter location on the display unit 112 associated with the first sensor S1.

At step 720, the method 700 may stop.

In some aspects, the method 700 may include additional steps that are not shown in FIG. 7. For example, the method 700 may include steps of determining a first position associated with the first sensor S1, and broadcasting the first position to the second sensors S2-S4. The method 700 may further include steps of obtaining a second position associated with the second sensors S2-S4 from the second devices S2-S4, and calculating a position matrix based on the first position and the second position.

In some aspects, broadcasting the first position to the second sensors S2-S4 (as described above) may include broadcasting the first position along with metadata. The metadata may include, for example, a sensor identifier number associated with the first sensor.

The method 700 may include a step of calculating an array manifold based on the position matrix and a wave number vector. The wave number vector may be a function of an azimuth angle and an elevation angle of incidence data associated with the signals obtained from the emitter 102. The method 700 may further include a step of conducting an eigen decomposition of the correlation matrix and partitioning the signals obtained from the emitter into signal and noise subspace.

In some aspects, the first sensor S1 may determine the line of bearing based on the array manifold and the eigen decomposition. In further aspects, the first sensor S1 may determine the line of bearing by multiplying the noise subspace by a conjugate transpose of the array manifold and generating a multiple signal classification (MUSIC) pseudo-spectrum based on the multiplication. The first sensor S1 may determine the line of bearing based on the MUSIC pseudo-spectrum.

In further aspects, the method 700 may include a step of calculating a second array manifold relative to the emitter location based on the line of bearing.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method to perform localization, the method comprising:
obtaining, by a first device from a plurality of devices, signals from an emitter, wherein the plurality of devices is communicatively coupled with each other and distributed non-uniformly in a network, and wherein each device, of the plurality of devices, is configured to obtain signals from the emitter;
converting, by the first device, the signals into a first complex amplitude;
broadcasting, by the first device, the first complex amplitude to one or more second devices of the plurality of devices;
obtaining, by the first device, a second complex amplitude from the one or more second devices;
constructing, by the first device, a correlation matrix based on the first complex amplitude and the second complex amplitude;
determining, by the first device, a line of bearing to the emitter based on the correlation matrix;
determining, by the first device, an emitter location based on the line of bearing; and
displaying, by the first device, the emitter location on a display unit.

2. The method of claim 1 further comprising:
determining a first position associated with the first device; and
broadcasting the first position to the one or more second devices.

3. The method of claim 2 further comprising:
obtaining a second position associated with the one or more second devices from the one or more second devices; and
calculating a position matrix based on the first position and the second position.

4. The method of claim 2, wherein broadcasting the first position comprises broadcasting the first position along with metadata, and wherein the metadata comprises a identifier number associated with the first device.

5. The method of claim 3 further comprising calculating an array manifold based on the position matrix and a wave number vector, wherein the wave number vector is a function of an azimuth angle and an elevation angle of incidence data associated with the signals obtained from the emitter.

6. The method of claim 5 further comprising conducting an eigen decomposition of the correlation matrix and partitioning the signals obtained from the emitter into signal and noise subspace.

7. The method of claim 6, wherein determining the line of bearing comprises determining the line of bearing based on the array manifold and the eigen decomposition.

8. The method of claim 6, wherein the determining the line of bearing comprises:
multiplying the noise subspace by a conjugate transpose of the array manifold;
generating a multiple signal classification (MUSIC) pseudo-spectrum based on the multiplication; and
determining the line of bearing based on the MUSIC pseudo-spectrum.

9. The method of claim 2, wherein broadcasting the first position comprises broadcasting the first position using a software-defined radio.

10. The method of claim 1 further comprising calculating a second array manifold relative to an emitter location based on the line of bearing.

11. A system to perform localization, the system comprising:
a plurality of devices communicatively coupled with each other and distributed non-uniformly in a network, wherein each device, of the plurality of devices, is configured to obtain signals from an emitter; and wherein a first device of the plurality of devices comprises:
a transceiver configured to receive the signals from the emitter and from one or more second devices of the plurality of devices; and
an evaluation unit communicatively coupled to the transceiver, wherein the evaluation unit is configured to:
obtain the signals from the emitter;
convert the signals into a first complex amplitude;
broadcast the first complex amplitude to the one or more second devices;
obtain a second complex amplitude from the one or more second devices;
construct a correlation matrix based on the first complex amplitude and the second complex amplitude;
determine a line of bearing to the emitter based on the correlation matrix;
determine an emitter location based on the line of bearing; and
display the emitter location on a display unit.

12. The system of claim 11, wherein the evaluation unit is further configured to:
determine a first position associated with the first device; and
broadcast the first position to the one or more second devices.

13. The system of claim 12, wherein the evaluation unit is further configured to:
obtain a second position of the one or more second devices from the one or more second devices; and
calculate a position matrix based on the first position and the second position.

14. The system of claim 12, wherein broadcasting the first position comprises broadcasting the first position along with metadata, and wherein the metadata comprises a identifier number associated with the first device.

15. The system of claim 13, wherein the evaluation unit is further configured to calculate an array manifold based on the position matrix and a wave number vector, wherein the wave number vector is a function of an azimuth angle and an elevation angle of incidence data associated with the signals obtained from the emitter.

16. The system of claim 15, wherein the evaluation unit is further configured to conduct an eigen decomposition of the correlation matrix and the signals obtained from the emitter into signal and noise subspace.

17. The system of claim 16, wherein the determination of the line of bearing is based on the array manifold and the eigen decomposition.

18. The system of claim 17, wherein to determine the line of bearing, the evaluation unit is configured to:
multiply the noise subspace by a conjugate transpose of the array manifold;
generate a multiple signal classification (MUSIC) pseudo-spectrum based on the multiplication; and
determine the line of bearing based on the MUSIC pseudo-spectrum.

19. The system of claim 11, wherein the evaluation unit is further configured to calculate a second array manifold relative to an emitter location based on the line of bearing.

20. A non-transitory computer-readable storage medium having instructions stored thereupon which, when executed by a processor, cause the processor to:
obtain, by a first device from a plurality of devices, signals from an emitter, wherein the plurality of devices is communicatively coupled with each other and distributed non-uniformly in a network, and wherein each device, of the plurality of devices, is configured to obtain signals from the emitter;
convert, by the first device, the signals into a first complex amplitude;
broadcast, by the first device, the first complex amplitude to one or more second devices of the plurality of devices;
obtain, by the first device, a second complex amplitude from the one or more second devices;
construct, by the first device, a correlation matrix based on the first complex amplitude and the second complex amplitude;
determine, by the first device, a line of bearing to the emitter based on the correlation matrix;
determine, by the first device, an emitter location based on the line of bearing; and
display, by the first device, the emitter location on a display unit.
